(19) United States
(12) Patent Application Publication
(10) Pub. No.: US 2024/0278637 A1
(43) Pub. Date: Aug. 22, 2024

(54) GRILLE SHUTTER CONTROL DEVICE IN VEHICLE

(71) Applicants: TOYOTA JIDOSHA KABUSHIKI KAISHA, Toyota-shi (JP); SUBARU CORPORATION, Tokyo (JP)

(72) Inventors: Yuki MIYAMOTO, Sunto-gun (JP); Tetsuya ICHIYANAGI, Nagoya-shi (JP)

(73) Assignees: TOYOTA JIDOSHA KABUSHIKI KAISHA, Toyota-shi (JP); SUBARU CORPORATION, Tokyo (JP)

(21) Appl. No.: 18/422,629

(22) Filed: Jan. 25, 2024

(30) Foreign Application Priority Data
Feb. 17, 2023 (JP) 2023-023788

(51) Int. Cl. B60K 11/08; F16D 65/847

(52) U.S. Cl. CPC B60K 11/085; F16D 65/847

(57) ABSTRACT

A grille shutter control device in a vehicle includes: a grille shutter provided at a front part of the vehicle; an actuator that adjusts a degree of opening of the grille shutter by applying a driving force to the grille shutter; a brake rotor that is provided in a front wheel located rearward of the grille shutter and that is reachable for a travel wind having passed through the grille shutter in a state different from a fully closed state; and a control unit that controls the actuator based on a value associated with a temperature of the brake rotor.

### CROSS-REFERENCE TO RELATED APPLICATION

This application claims priority to Japanese Patent Application No. 2023-023788 filed on Feb. 17, 2023, incorporated herein by reference in its entirety.

### BACKGROUND

### 1. Technical Field

The present disclosure relates to a grille shutter control device in a vehicle.

### 2. Description of Related Art

The vehicle disclosed in Japanese Unexamined Patent Application Publication No. 2021-095077 (JP 2021-095077 A) has first ducts and second ducts that are connected to a front bumper. Air (a travel wind) coming out of a rear-end opening of each first duct is discharged to the outside of the vehicle while air coming out of a rear-end opening of each second duct is supplied to a brake member of a front wheel. This vehicle has switching valves that each operate according to the temperature of the corresponding brake member. When the temperature of the brake member becomes high, the switching valve works such that air is supplied to the brake member by passing through the second duct.

### SUMMARY

JP 2021-095077 A described above leaves room for improvement in terms of the method of cooling each brake member according to the temperature of the brake member.

In view of this fact, the present disclosure aims to obtain a grille shutter control device in a vehicle that can effectively cool a brake rotor using a grille shutter, without unnecessarily adding to air resistance to the vehicle.

A grille shutter control device in a vehicle described in claim 1 includes: a grille shutter provided at a front part of the vehicle; an actuator that adjusts a degree of opening of the grille shutter by applying a driving force to the grille shutter; a brake rotor that is provided in a front wheel located rearward of the grille shutter and that is reachable for a travel wind having passed through the grille shutter in a state different from a fully closed state; and a control unit that controls the actuator based on a value associated with a temperature of the brake rotor.

In the grille shutter control device in a vehicle of claim 1, the control unit controls the actuator based on the value associated with the temperature of the brake rotor and thereby adjusts the degree of opening of the grille shutter.

Since the degree of opening of the grille shutter is thus adjusted based on the value associated with the temperature of the brake rotor, the actuator can be controlled so as to reduce the degree of opening of the grille shutter when there is less need to lower the temperature of the brake rotor.

Thus, the grille shutter control device in a vehicle of claim 1 can effectively cool the brake rotor using the grille shutter, without unnecessarily adding to air resistance to the vehicle.

The grille shutter control device in a vehicle described in claim 2 is the grill shutter control device of claim 1 including a temperature estimation unit that estimates a temperature of the brake rotor, wherein the control unit controls the actuator based on the temperature of the brake rotor estimated by the temperature estimation unit.

In the grille shutter control device in a vehicle of claim 2, the temperature estimation unit estimates the temperature of the brake rotor. Further, the control unit controls the actuator based on the temperature of the brake rotor estimated by the temperature estimation unit. Therefore, the grille shutter control device in a vehicle of claim 2 can effectively cool the brake rotor using the grille shutter, without unnecessarily adding to air resistance to the vehicle.

The grille shutter control device in a vehicle described in claim 3 is the grill shutter control device of claim 1, wherein the vehicle has an electric motor as a driving source, and the control unit controls the actuator based on at least one of an output limit amount of a battery that is able to supply electricity to the electric motor as well as store electricity generated by the electric motor, regenerative availability of the battery, and a gradient of a road surface on which the vehicle is traveling.

The control unit of the grille shutter control device in a vehicle of claim 3 controls the actuator based on at least one of the output limit amount of the battery provided in the vehicle, the regenerative availability of the battery, and the gradient of the road surface on which the vehicle is traveling. Further, the actuator controlled by the control unit adjusts the degree of opening of the grille shutter. Thus, the grille shutter control device in a vehicle of claim 3 can effectively cool the brake rotor using the grille shutter, without unnecessarily adding to air resistance to the vehicle.

Further, the grille shutter control device in a vehicle of claim 3 adjusts the degree of opening of the grille shutter without using an estimated value of the temperature of the brake rotor. Therefore, the grille shutter control device in a vehicle of claim 3 can control the degree of opening of the grille shutter free of the influence of error between an estimated value and an actual value of the temperature of the brake rotor.

The grille shutter control device in a vehicle described in claim 4 is the grill shutter control device of claim 3, wherein the control unit compares a first degree of opening that is a target degree of opening of the grille shutter obtained based on the output limit amount and the regenerative availability and a second degree of opening that is a target degree of opening of the grille shutter obtained based on the gradient and the regenerative availability, and controls the actuator such that the degree of opening of the grille shutter meets a value of the first degree of opening or the second degree of opening, whichever is larger.

In the grille shutter control device in a vehicle of claim 4, the first degree of opening of the grille shutter obtained based on the output limit amount and the regenerative availability and the second degree of opening of the grille shutter obtained based on the road surface gradient and the regenerative availability are compared. Further, the actuator is controlled such that the degree of opening of the grille shutter meets the value of the first degree of opening or the second degree of opening, whichever is larger. Thus, the grille shutter control device in a vehicle of claim 4 is likely to prevent the brake rotor from reaching an excessively high temperature.

The grille shutter control device in a vehicle according to the present disclosure has the excellent advantage of being able to effectively cool the brake rotor using the grille shutter, without unnecessarily adding to air resistance to the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic side view of a front part of a vehicle to which a grille shutter control device according to a first embodiment is applied;

FIG. 2 is a functional block diagram of an ECU of FIG. 1;

FIG. 3 is a view showing a degree-of-opening control map that is recorded in an ROM of the ECU;

FIG. 4 is a flowchart showing a process executed by a CPU of the ECU;

FIG. 5A is a view showing a first map that is recorded in an ROM of an ECU of a vehicle to which a grille shutter control device according to a second embodiment is applied;

FIG. 5B is a view showing a second map that is recorded in the ROM of the ECU of the vehicle to which the grille shutter control device according to the second embodiment is applied; and

FIG. 6 is a flowchart showing a process executed by a CPU of the ECU.

### DETAILED DESCRIPTION OF EMBODIMENTS

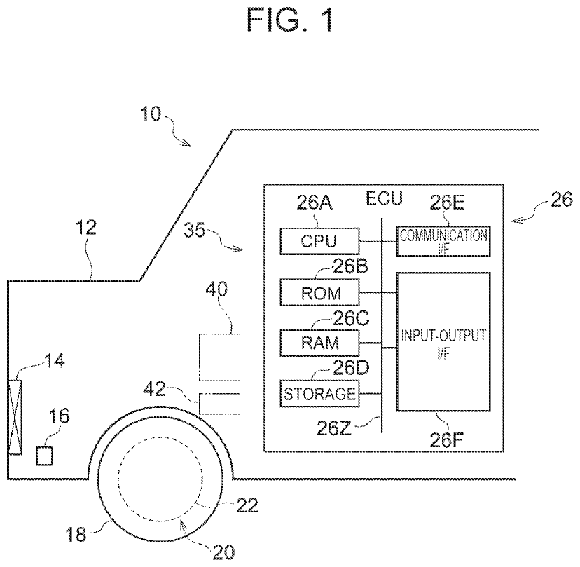

A first embodiment of a grille shutter control device in a vehicle according to the present disclosure will be described below with reference to FIG. 1 to FIG. 4.

As shown in FIG. 1, a grille shutter 14 is provided at a front end portion of a vehicle body 12 of a vehicle 10 to which a grille shutter control device 35 of the first embodiment is applied. The grille shutter 14 has a plurality of rotatable fins (not shown). The vehicle 10 further has an actuator 16 that can generate a driving force for rotating each fin of the grille shutter 14. The actuator 16 is, for example, an electric motor. Further, at a front part of the vehicle body 12, a radiator (not shown) located on a rear side of the grille shutter 14 is provided.

The vehicle 10 further has a pair of left and right front wheels 18 and a pair of left and right rear wheels (not shown). The vehicle 10 has four brake devices 20 respectively corresponding to the front wheels 18 and the rear wheels. Each brake device 20 has a brake rotor 22 fixed on the wheel and a brake pad (not shown) that generates a braking force by contacting the brake rotor 22. When the grille shutter 14 of the vehicle 10 traveling forward is not in a fully closed state, a travel wind (air) having passed through the grille shutter 14 is supplied to the brake rotors 22 of the left and right front wheels 18 located on the rear side of the grille shutter 14, so that the brake rotors 22 are cooled by the travel wind.

As shown in FIG. 1, the vehicle 10 has an electronic control unit (ECU) 26 as a hardware configuration.

The ECU 26 includes, in its configuration, a central processing unit (CPU; computer) 26A, a read-only memory (ROM) 26B, a random-access memory (RAM) 26C, a storage 26D, a communication I/F 26E, and an input-output I/F 26F. The CPU 26A, the ROM 26B, the RAM 26C, the storage 26D, the communication I/F 26E, and the input-output I/F 26F are communicably connected to one another through an internal bus 26Z.

The CPU 26A is a central arithmetic processing unit, and executes various programs and controls parts. The CPU 26A retrieves programs from the ROM 26B or the storage 26D and execute the programs using the RAM 26C as a workspace. The CPU 26A performs control of components and various arithmetic processes in accordance with programs stored in the ROM 26B or the storage 26D. The CPU 26A can acquire information about the time of day from a timer.

The ROM 26B stores various programs and various pieces of data. The RAM 26C temporarily stores programs or data as a workspace. The storage 26D is formed by a storage device such as a hard disk drive (HDD) or a solid-state drive (SSD) and stores various programs and various pieces of data.

The communication I/F 26E is an interface for connecting to a different ECU (not shown) from the ECU 26 through an external bus (not shown). For this interface, a communication standard based on a CAN protocol, for example, is used.

The input-output I/F 26F is an interface for communicating with various devices. These devices include, for example, the actuator 16.

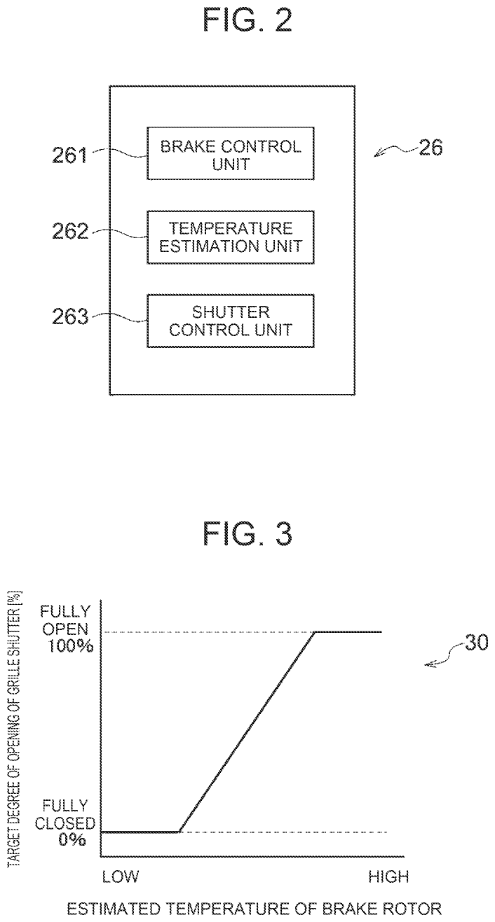

FIG. 2 shows one example of the functional configuration of the ECU 26 as a block diagram. The ECU 26 has, in its functional configuration, a brake control unit 261, a temperature estimation unit 262, and a shutter control unit 263. The brake control unit 261, the temperature estimation unit 262, and the shutter control unit 263 are realized as the CPU 26A retrieves programs stored in the ROM 26B and executes these programs.

When a brake pedal (not shown) is stepped on by a driver, the brake control unit 261 controls the brake actuator so as to bring each brake pad into contact with the brake rotor 22. Thus, a braking force is generated between the brake pad and the brake rotor 22. Further, friction heat is generated between the brake pad and the brake rotor 22.

The temperature estimation unit 262 estimates the temperature of the brake rotor 22 provided in each front wheel 18 without using a temperature sensor. That is, the vehicle 10 is not provided with a temperature sensor for measuring the temperature of the brake rotor 22. The temperature estimation unit 262 estimates the temperature of the brake rotor 22 provided in each front wheel 18 using, for example, the method disclosed in Japanese Unexamined Patent Application Publication No. 2022-177498 (JP 2022-177498 A).

Here, the temperature estimation method described in JP 2022-177498 A will be briefly described. The temperature estimation unit 262 (CPU 26A) estimates the temperature of the brake rotor 22 once every predetermined sampling time (ECU calculation period). A temperature T_{R} of the brake rotor 22 at a predetermined time of calculation is estimated to be a temperature obtained by adding a temperature rise of the brake rotor 22 during a sampling time Δt to a temperature T_{Rbefore} of the brake rotor 22 at the time of the last calculation. Thus, a temperature Tr can be calculated using the following Formula (1). Symbols in Formula (1) represent the following contents:
T_{R}: temperature of brake rotor (° C.)
T_{Rbefore}: last value of temperature of brake rotor (° C.)
Qᵢₙ: amount of heat reception of brake rotor (kw)
Qₒᵤₜ: amount of heat release of brake rotor (kw)
Mᵣ: mass of brake rotor (kg)
C^{P}: constant pressure specific heat (J/kg/° C.)

$$\begin{matrix}[ Formula 1 ] & \\ {T}_{R} = {T}_{R before} + \frac{{Q}_{in} - {Q}_{out}}{{M}_{r} {C}_{p}} & Formula ( 1 )\end{matrix}$$

The amount of heat reception Qᵢₙ of the brake rotor 22 can be calculated based on, for example, the following Formulae (2) and (3). That is, the amount of heat reception Qᵢₙ can be estimated based on work done by a frictional force F between the brake pad and the brake rotor 22. Symbols in Formulae (2) and (3) represent the following contents:
P: fluid pressure of wheel cylinder that is part of brake actuator
μ: coefficient of friction between brake pad and brake rotor 22
Ab: area of sliding part between brake pad and brake rotor 22
V: vehicle speed (m/s)
r: radius that is distance from central axis of rotation of wheel to sliding part between brake pad and brake rotor 22 (m)
R: dynamic loaded radius of tire (m)
Δt: sampling time (ECU calculation period)

$$\begin{matrix}[ Formula 2 ] & \\ F = 2 \cdot P \cdot μ \cdot {A}_{b} & Formula ( 2 )\end{matrix}$$

$$\begin{matrix}[ Formula 3 ] & \\ {Q}_{in} = F \cdot V \cdot ( 2 π r / 2 π R ) \cdot Δ t & Formula ( 3 )\end{matrix}$$

The amount of heat release Qₒᵤₜ of the brake rotor 22 can be calculated using the following Formula (4). Symbols in Formula (4) represent the following contents:
h: coefficient of heat transfer (W/m²/° C.)
A_{b}: heat release area of brake rotor (m²)
Tₐₜₘ: outside air temperature (° C.)
Δt: sampling time (ECU calculation period)

$$\begin{matrix}[ Formula 4 ] & \\ {Q}_{out} = h \cdot {A}_{b} \cdot ( {T}_{Rbefore} - {T}_{atm} ) \cdot Δ t & Formula ( 4 )\end{matrix}$$

Using the estimated temperature of the brake rotor 22 that the temperature estimation unit 262 has calculated using Formulae (1) to (4) and a degree-of-opening control map 30 shown in FIG. 3, the shutter control unit 263 calculates a target degree of opening of the grille shutter 14 at a predetermined time of calculation. This degree-of-opening control map 30 is recorded in the ROM 26B, and has been created based on a relationship among an estimated temperature of the brake rotor 22 at a predetermined time, a target degree of opening of the grille shutter 14 at that time, and a temperature (target temperature) of the brake rotor 22 after the degree of opening of the grille shutter 14 has been controlled in accordance with the degree-of-opening control map 30. That is, the target degree of opening of the grille shutter 14 is determined with the estimated temperature of the brake rotor 22 serving as a parameter for the degree-of-opening control map 30. When the actuator 16 is controlled based on this degree-of-opening control map 30 such that the degree of opening of the grille shutter 14 meets the target degree of opening, the temperature of the brake rotor 22 is likely to meet the target temperature.

Of the components having been described above, the grille shutter 14, the actuator 16, the brake rotor 22, and the ECU 26 (CPU 26A) are constituent elements of the grille shutter control device 35.

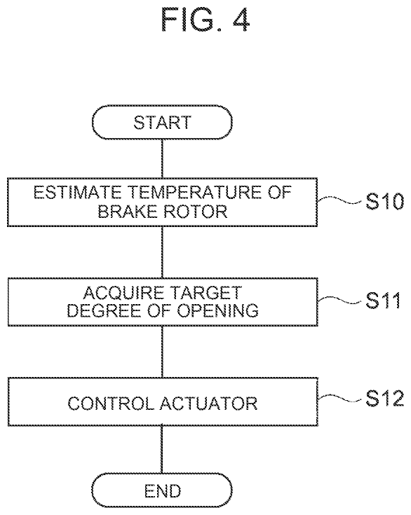

Next, a process executed by the CPU 26A of the ECU 26 will be described. The CPU 26A repeatedly executes the process of the flowchart shown in FIG. 4 every time a predetermined time elapses. It is assumed that the brake pad intermittently contacts the brake rotor 22 during execution of this process.

In step S10 (hereinafter the word “step” will be omitted), the CPU 26A estimates the temperature of each brake rotor 22.

The CPU 26A having ended the process of S10 moves to S11, where it applies the estimated temperature of the brake rotor 22 acquired in S10 to the degree-of-opening control map 30 to thereby acquire a target degree of opening of the grille shutter 14.

The CPU 26A having ended the process of S11 moves to S12, where it controls the actuator 16 such that the degree of opening of the grille shutter 14 meets the target degree of opening acquired in S11. As a result, the degree of opening of the grille shutter 14 is changed to the target degree of opening acquired in S11. Therefore, when a predetermined time elapses after the process of S12 is executed, the temperature of the brake rotor 22 of each front wheel 18 is likely to meet the aforementioned target temperature.

As has been described above, according to the first embodiment, the actuator 16 is controlled based on the estimated temperature of the brake rotor 22 (a value associated with the temperature) estimated by the CPU 26A (temperature estimation unit 262) and the degree-of-opening control map 30. Accordingly, the degree of opening of the grille shutter 14 is adjusted such that the temperature of the brake rotor 22 meets the target temperature. Further, as the degree-of-opening control map 30 shows, when the estimated temperature of the brake rotor 22 is higher, the target degree of opening of the grille shutter 14 becomes larger, whereas when the estimated temperature of the brake rotor 22 is lower, the target degree of opening of the grille shutter 14 becomes smaller. Thus, the actuator 16 is controlled so as to reduce the degree of opening of the grille shutter 14 when there is less need to lower the temperature of the brake rotor 22. Therefore, the grille shutter control device 35 of the first embodiment can effectively cool the brake rotors 22 of the front wheels 18 using the grille shutter 14, without unnecessarily adding to air resistance to the vehicle 10.

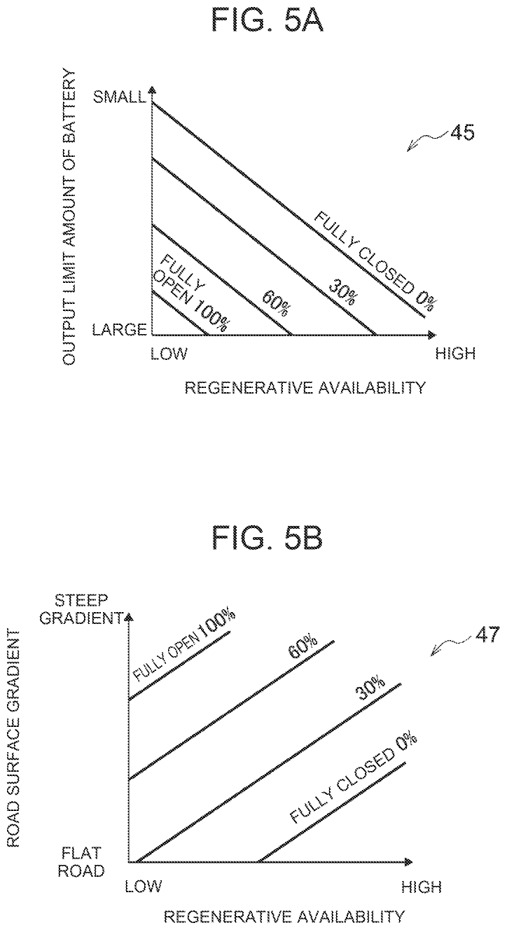

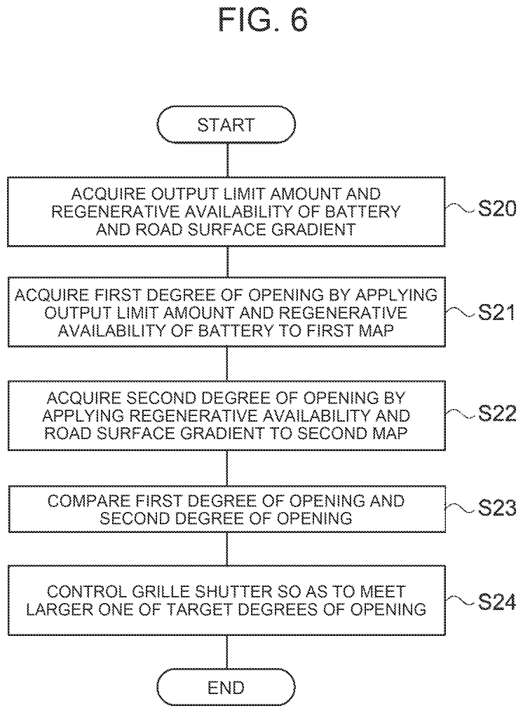

Next, a second embodiment of the grille shutter control device 35 in a vehicle according to the present disclosure will be described with reference to FIG. 5A, FIG. 5B, and FIG. 6. The same members as in the first embodiment will be only denoted by the same reference signs and detailed description thereof will be omitted. A vehicle 10 of the second embodiment has an electric motor 40 (see the imaginary line in FIG. 1) as a driving source. That is, the vehicle 10 is a hybrid electric vehicle, a plug-in hybrid electric vehicle, a fuel cell electric vehicle, or a battery electric vehicle. The vehicle 10 further has a battery 42 (see the imaginary line in FIG. 1) that can supply electricity to the electric motor 40 as well as store electricity generated by the electric motor 40. The electric motor 40 and the battery 42 are connected to an ECU 26.

As is clear from Formula (1) described above, the temperature estimation method described in JP 2022-177498 A uses the temperature T_{Rbefore} of the brake rotor 22 at the time of the last calculation when estimating the temperature of the brake rotor 22. However, it is highly likely that error exists between the temperature Tr acquired at each time of calculation and the actual value of the temperature of the brake rotor 22. Moreover, the amount of error included in the temperature Tr is highly likely to increase as the number of times of calculation increases. In the case where the degree of opening of the grille shutter 14 is thus controlled using the temperature of the brake rotor 22 acquired at a time of calculation preceding the time of the current calculation (current time), the degree of opening of the grille shutter 14 may fail to be set to an ideal degree. In the second embodiment, therefore, the grille shutter 14 (actuator 16) is controlled by the method to be described below.

The above-described Qᵢₙ can be calculated using the following Formula (5). Symbols in Formula (5) represent the following contents.
M: mass of vehicle (kg)
V: vehicle speed (m/s)
V_{before}: last value of vehicle speed (m/s)
α: braking distribution of brake to front wheel
g: gravitational acceleration (m/s²)
Δt: sampling time (ECU calculation period)
θ: estimated road surface gradient (deg)
T_{HV}: regenerative torque of driveshaft per wheel (Nm)
R: dynamic loaded radius of tire (m)

$$\begin{matrix}[ Formula 5 ] & \\ {Q}_{in} = {\underbrace{\frac{1}{2} M ( {V}^{2} - {V}_{before}^{2} )}}_{kinetic energy} * α * \frac{1}{2} + {\underbrace{MgV * Δ t * sin θ}}_{potential energy} * α * \frac{1}{2} - {\underbrace{\frac{{T}_{HV}}{2 R} * V * Δ t}}_{regenerative energy} & Formula ( 5 )\end{matrix}$$

Formula (5) shows that the amount of heat reception Qᵢₙ is the sum of kinetic energy, potential energy, and regenerative energy. Further, Formula (4) shows that the amount of heat release Qₒᵤₜ is proportional to the coefficient of heat transfer h. Therefore, the temperature of the brake rotor 22 can be brought close to the target temperature by determining a coefficient of heat transfer h that makes the magnitude of the amount of heat release Qₒᵤₜ appropriate relative to the amount of heat reception Qᵢₙ.

The ECU 26 of the second embodiment has, in its functional configuration, a brake control unit 261 and a shutter control unit 263. The function of the brake control unit 261 is the same as in the first embodiment. The shutter control unit 263 of the second embodiment calculates a target degree of opening of the grille shutter 14 at a predetermined time using a first map 45 shown in FIG. 5A and a second map 47 shown in FIG. 5B. The first map 45 and the second map 47 are recorded in the ROM 26B. The first map 45 has been created based on a relationship among an output limit amount of the battery 42 to be described later, a road surface gradient of a road on which the vehicle 10 is traveling, and a target degree of opening of the grille shutter 14. Thus, the output limit amount and the road surface gradient are parameters of the first map 45. On the other hand, the second map 47 has been created based on regenerative availability of the battery 42 to be described later, the road surface gradient, and the target degree of opening of the grille shutter 14. Thus, the regenerative availability and the road surface gradient are parameters of the second map 47. In the following, the output limit amount of the battery 42, the regenerative availability of the battery 42, and the road surface gradient of the road will be described.

It is known that the temperature of the brake rotor 22 tends to rise when the vehicle 10 accelerates and decelerates repeatedly. Thus, there is a correlation between the kinetic energy of the vehicle 10 and the temperature of the brake rotor 22. When the vehicle 10 accelerates and decelerates repeatedly, the temperatures of battery-related parts including the battery 42 that supplies electricity to the electric motor 40 etc. and receives a supply of electricity from the electric motor 40 tend to rise. The battery-related parts include, other than the battery 42, for example, a wire harness connected to the battery 42. To protect the battery-related parts, the ECU 26 of the vehicle 10 controls the output limit amount (output limit value) of the battery 42 based on the temperature of the battery 42. One method of calculating such an output limit amount of a battery (celebration method) is disclosed in, for example, Japanese Unexamined Patent Application Publication No. 2011-168232 (JP 2011-168232 A). The shutter control unit 263 (CPU 26A) can acquire (calculate) the output limit amount that changes according to the temperature of the battery 42. Since the output limit amount of the battery 42 has a correlation with the kinetic energy of the vehicle 10, the output limit amount of the battery 42 has a correlation with the amount of heat reception Qᵢₙ.

A maximum amount of regeneration of the battery 42 is determined by the regenerative availability of the battery 42. The regenerative availability of the battery 42 represents an upper limit amount of regenerative electricity (regenerative energy) that the battery 42 can receive from the electric motor 40, and varies according to, for example, the state-of-charge (SOC) and the temperature of the battery 42. That is, when the regenerative availability of the battery 42 is low, a braking force by regenerative braking cannot be increased, so that the braking force that the brake device 20 should generate increases, resulting in a larger amount of heat reception Qᵢₙ. Thus, the regenerative availability and the amount of heat reception Qᵢₙ have a correlation. Since the ECU 26 is connected to the battery 42, the shutter control unit 263 (CPU 26A) can acquire (calculate) the regenerative availability of the battery 42.

The potential energy of the vehicle 10 and the road surface gradient of the road on which the vehicle 10 is traveling have a correlation. Therefore, the road surface gradient and the amount of heat reception Qᵢₙ have a correlation. Methods of calculating a road surface gradient are commonly known. For example, the shutter control unit 263 (CPU 26A) can compare a rate of acceleration of the vehicle 10 traveling on a road having no gradient when the accelerator pedal is stepped on a predetermined amount and a rate of acceleration of the vehicle 10 traveling on another road when the accelerator pedal is stepped on the same amount, and thereby acquire (calculate) the road surface gradient of this other road. In addition, the shutter control unit 263 can acquire a road surface gradient using a detection value of a gyroscope sensor provided in the vehicle 10.

Thus, the output limit amount of the battery 42, the regenerative availability of the battery 42, and the road surface gradient of the road are values associated with the temperature of the brake rotor 22 and have a correlation with the amount of heat reception Qᵢₙ. Therefore, the first map 45 has been created based on the relationship among the output limit amount of the battery 42, the regenerative availability of the battery 42, and the target degree of opening of the grille shutter 14. Similarly, the second map 47 has been created based on the regenerative availability of the battery 42, the road surface gradient, and the target degree of opening of the grille shutter 14. The target degrees of opening shown by the first map 45 and the second map 47 substantially have a correlation with the coefficient of heat transfer h of Formula (4).

Next, a process executed by the CPU 26A will be described. The CPU 26A repeatedly executes the process of the flowchart shown in FIG. 6 each time a predetermined time elapses. It is assumed that the brake pad intermittently contacts the brake rotor 22 during execution of this process.

In S20, the CPU 26A acquires the output limit amount and the regenerative availability of the battery 42 and the road surface gradient of the road.

The CPU 26A having ended the process of S20 moves to S21, where it applies the output limit amount and the regenerative availability of the battery 42 acquired in S20 to the first map 45 to thereby acquire a first degree of opening that is a target degree of opening of the grille shutter 14.

The CPU 26A having ended the process of S21 moves to S22, where it applies the regenerative availability of the battery 42 and the road surface gradient acquired in S20 to the second map 47 to thereby acquire a second degree of opening that is a target degree of opening of the grille shutter 14.

The CPU 26A having ended the process of S22 moves to S23, where it compares the first degree of opening and the second degree of opening to determine which is larger.

The CPU 26A having ended the process of S23 moves to S24, where it selects a larger one of the first degree of opening and the second degree of opening as the target degree of opening. Further, the CPU 26A controls the actuator 16 such that the degree of opening of the grille shutter 14 meets this target degree of opening. As a result, the degree of opening of the grille shutter 14 is changed to the target degree of opening. Therefore, when a predetermined time elapses after the process of S24 is executed, the temperature of the brake rotor 22 of each front wheel 18 is likely to meet the aforementioned target temperature.

As has been described above, when the amount of heat reception Qᵢₙ of the brake rotor 22 is larger, the temperature of the brake rotor 22 becomes higher, and therefore, in this case, the target degree of opening (coefficient of heat transfer h) of the grille shutter 14 having a correlation with the amount of heat release Qₒᵤₜ becomes larger. On the other hand, when the amount of heat reception Qᵢₙ is smaller, the target degree of opening (coefficient of heat transfer h) of the grille shutter 14 becomes smaller. In the second embodiment, therefore, the brake rotors 22 can be effectively cooled using the grille shutter 14, without unnecessarily adding to air resistance to the vehicle 10.

Further, the degree of opening of the grille shutter 14 is adjusted without using an estimated temperature of the brake rotor 22 acquired at a time of calculation preceding the time of the current calculation (current time). Thus, the degree of opening of the grille shutter 14 can be controlled free of the influence of error between the estimated value and the actual value of the temperature of the brake rotor 22.

Moreover, in the second embodiment, the first degree of opening of the grille shutter 14 obtained based on the output limit amount and the regenerative availability of the battery 42 and the second degree of opening of the grille shutter 14 obtained based on the road surface gradient and the regenerative availability are compared. Further, the actuator 16 is controlled such that the degree of opening of the grille shutter 14 meets the value of the first degree of opening or the second degree of opening, whichever is larger. Thus, compared with when the actuator 16 is controlled such that the degree of opening of the grille shutter 14 meets the value of the first degree of opening or the second degree of opening, whichever is smaller, the brake rotor 22 is likely to be prevented from reaching an excessively high temperature.

While the grille shutter control devices in a vehicle according to the embodiments have been described above, design changes can be made as appropriate to the grille shutter control devices in a vehicle within such a range that no departure is made from the gist of the present disclosure.

For example, in the first embodiment, the temperature of the brake rotor 22 may be detected using a temperature sensor that is provided so as to form a small clearance between itself and the brake rotor 22, and the CPU 26A may control the actuator 16 such that the degree of opening of the grille shutter 14 meets a target degree of opening obtained by applying a detection value of this temperature sensor (a value associated with the temperature of the brake rotor 22) to the degree-of-opening control map 30.

In the second embodiment, the CPU 26A may control the actuator 16 based on at least one of the output limit amount of the battery 42, the regenerative availability thereof, and the road surface gradient.

What is claimed is:

1. A grille shutter control device in a vehicle, the grill shutter control device comprising:
a grille shutter provided at a front part of the vehicle;
an actuator that adjusts a degree of opening of the grille shutter by applying a driving force to the grille shutter;
a brake rotor that is provided in a front wheel located rearward of the grille shutter and that is reachable for a travel wind having passed through the grille shutter in a state different from a fully closed state; and
a control unit that controls the actuator based on a value associated with a temperature of the brake rotor.

2. The grille shutter control device in a vehicle according to claim 1, comprising a temperature estimation unit that estimates a temperature of the brake rotor, wherein the control unit controls the actuator based on the temperature of the brake rotor estimated by the temperature estimation unit.

3. The grille shutter control device in a vehicle according to claim 1, wherein:
the vehicle has an electric motor as a driving source; and
the control unit controls the actuator based on at least one of an output limit amount of a battery that is able to supply electricity to the electric motor as well as store electricity generated by the electric motor, regenerative availability of the battery, and a gradient of a road surface on which the vehicle is traveling.

4. The grille shutter control device in a vehicle according to claim 3, wherein the control unit compares a first degree of opening that is a target degree of opening of the grille shutter obtained based on the output limit amount and the regenerative availability and a second degree of opening that is a target degree of opening of the grille shutter obtained based on the gradient and the regenerative availability, and controls the actuator such that the degree of opening of the grille shutter meets a value of the first degree of opening or the second degree of opening, whichever is larger.
